(19) United States
(12) Patent Application Publication
(10) Pub. No.: US 2024/0396093 A1
(43) Pub. Date: Nov. 28, 2024

(54) POWER STORAGE CELL

(71) Applicant: TOYOTA JIDOSHA KABUSHIKI KAISHA, Toyota-shi (JP)

(72) Inventors: Takeshi ABE, Okazaki-shi (JP); Ryuta Sugiura, Toyota-shi (JP); Tomoyuki Uezono, Okazaki-shi (JP); Takenori Ikeda, Owariasahi-shi (JP); Yuki Takahashi, Miyoshi-shi (JP); Kenta Kimura, Toyota-shi (JP)

(73) Assignee: TOYOTA JIDOSHA KABUSHIKI KAISHA, Toyota-shi (JP)

(21) Appl. No.: 18/443,549

(22) Filed: Feb. 16, 2024

(30) Foreign Application Priority Data
May 26, 2023 (JP) 2023-086799

(51) Int. Cl. H01M 10/0587

(52) U.S. Cl. CPC H01M 10/0587

(57) ABSTRACT

The power storage cell includes a cell case, a wound electrode body, a fixing member, and an electrolytic solution. The cell case houses a wound electrode body, a fixing member, and an electrolytic solution. The wound electrode body is formed by winding an electrode and a separator. The fixing member fixes a winding end of the wound electrode body in the winding direction. The fixing member includes an adhesive component. The adhesive component is soluble in the electrolytic solution.

### CROSS-REFERENCE TO RELATED APPLICATION

This application claims priority to Japanese Patent Application No. 2023-086799 filed on May 26, 2023, incorporated herein by reference in its entirety.

### BACKGROUND

### 1. Technical Field

The present disclosure relates to a power storage cell.

### 2. Description of Related Art

WO2019/064806 discloses a tape for fixing a winding end of a wound electrode body.

### SUMMARY

The wound electrode body is formed by winding electrodes and separators. In order to insert the wound electrode body into a cell case, the winding end of the wound electrode body may be fixed by, for example, an adhesive tape. For example, the electrodes may swell during charging of the power storage cell. Since the winding end of the wound electrode body is fixed, stress caused by the swell of the electrodes may concentrate on the winding end.

An object of the present disclosure is to reduce stress concentration at a winding end of a wound electrode body.

A technical configuration and effects of the present disclosure will be described below. However, the operation mechanism includes estimation. The operation mechanism does not limit the technical scope of the present disclosure.

1. A power storage cell includes a cell case, a wound electrode body, a fixing member, and an electrolytic solution. The cell case houses the wound electrode body, the fixing member, and the electrolytic solution. The wound electrode body is provided by winding electrodes and separators. The fixing member fixes a winding end of the wound electrode body in a winding direction. The fixing member includes an adhesive component. The adhesive component is soluble in the electrolytic solution.

The fixing member includes the adhesive component. By fixing the winding end with the adhesive component, the wound electrode body can smoothly be inserted into the cell case. After the insertion into the cell case, the adhesive component dissolves in the electrolytic solution. Therefore, the fixing force at the winding end may decrease. By the decrease in the fixing force, it is expected that the stress concentration at the winding end is reduced.

2. The power storage cell described in “1” above may include, for example, the following configuration. The fixing member further includes a base. The base supports the adhesive component.

With the base of the fixing member, the strength is expected to be improved. By the improvement in the strength, it is expected, for example, that the fixing member maintains a predetermined shape until the wound electrode body is inserted into the cell case.

3. The power storage cell described in “1” above may include, for example, the following configuration. At least part of the fixing member is disposed on an inner peripheral side of an outermost layer of the wound electrode body in a radial direction of the wound electrode body. A central portion of the fixing member is positioned on an inner side of the winding end of the wound electrode body in the winding direction of the wound electrode body.

The fixing member may be disposed, for example, over the winding end. For example, when the fixing member is disposed on the outer peripheral side of the outermost layer, a step may be formed on the outer surface of the wound electrode body due to the thickness of the fixing member. Stress concentration may occur in the step. Since the fixing member is disposed on the inner peripheral side of the outermost layer, it is expected that the step is reduced. Further, the projecting margin of the fixing member from the winding end may be reduced.

4. The power storage cell described in “2” above may include, for example, the following configuration. At least part of the fixing member is disposed on an inner peripheral side of an outermost layer of the wound electrode body in a radial direction of the wound electrode body. In the winding direction of the wound electrode body, the base of the fixing member is positioned on an inner side of the winding end of the wound electrode body. The base of the fixing member is not positioned on an outer side of the winding end of the wound electrode body.

Since the base of the fixing member does not project outward from the winding end in the winding direction, it is expected that the step is reduced.

An embodiment of the present disclosure (hereinafter, may be abbreviated to “present embodiment”) will be described below. However, the present embodiment does not limit the technical scope of the present disclosure. The present embodiment is exemplary in all respects. The present embodiment is non-limiting. The technical scope of the present disclosure includes all modifications within the meaning and scope equivalent to the description in the claims. For example, it is originally planned to extract appropriate configurations from the present embodiment and combine them as appropriate.

Geometric terms should not be construed in a strict sense. Examples of the geometric terms include “parallel”, “vertical”, and “orthogonal”. For example, “parallel” may deviate somewhat from “parallel” in a strict sense. The geometric terms may include, for example, design, work, or manufacturing tolerances or variations. Dimensional relationships in each drawing may not match actual dimensional relationships. The dimensional relationships in each drawing may be changed to facilitate understanding of readers. For example, the length, width, and thickness may be changed. Further, part of the configuration may be omitted.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view illustrating an example of a power storage cell according to the present embodiment;

FIG. 2 is a schematic diagram illustrating an example of a wound electrode body according to the present embodiment;

FIG. 3 is a schematic cross-sectional view illustrating an example of a fixing member according to the present embodiment;

FIG. 4 is a schematic cross-sectional view showing a first arrangement example;

FIG. 5 is a schematic cross-sectional view showing a second exemplary arrangement; and

FIG. 6 is a schematic cross-sectional view illustrating a third arrangement example.

### DETAILED DESCRIPTION OF EMBODIMENTS

### 1. Power Storage Cell

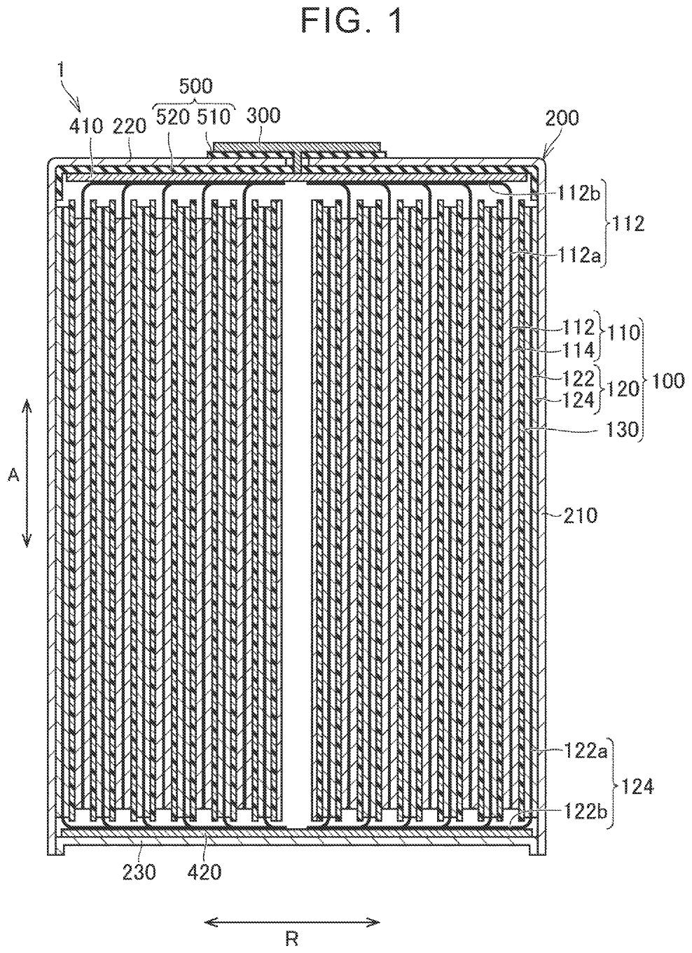

FIG. 1 is a schematic cross-sectional view illustrating an example of a power storage cell according to the present embodiment. The power storage cell 1 can be applied to any application. The power storage cell 1 may be used, for example, as a power source of a vehicle. The power storage cell 1 includes a cell case 200, a wound electrode body 100, and an electrolytic solution (not shown). The power storage cell 1 may further include, for example, an external terminal 300, a positive electrode current collector plate 410, a negative electrode current collector plate 420, an insulating member 500, and the like.

### 2. Wound Electrode Body

The wound electrode body 100 is formed by winding an electrode and a separator 130. The “electrode” is a generic term for the positive electrode 110 and the negative electrode 120. That is, the wound electrode body 100 includes a positive electrode 110, a negative electrode 120, and a separator 130. Each of the positive electrode 110, the negative electrode 120, and the separator 130 has a band shape. Each of the positive electrode 110, the negative electrode 120, and the separator 130 has a sheet shape. For example, a stacked body may be formed by stacking the positive electrode 110, the separator 130, and the negative electrode 120 in this order. The wound electrode body 100 may be formed by winding the laminated body in a spiral shape. The wound electrode body 100 may be formed in a flat shape, for example.

The positive electrode 110 includes a positive electrode collector foil 112 and a positive electrode active material layer 114. The positive electrode collector foil 112 may include, for example, A1 or the like. The positive electrode collector foil 112 includes a first region 112a and a second region 112b. The positive electrode active material layer 114 is disposed in the first region 112a. The positive electrode active material layer 114 may include, for example, a lithium nickel composite oxide. The second region 112b adjoins the first region 112a. The second region 112b is arranged at the axial end. The “axial direction” is the direction A of FIG. 1. The second region 112b includes a plurality of tabs. The plurality of tabs is separated in the winding direction of the wound electrode body 100. For example, a plurality of tabs may be welded to the second region 112b. For example, a part of the second region 112b may be tab-processed. Each tab collapses radially inward. The “radial direction” is the R direction in FIG. 1 and the like. The outer surface of each tab forms a generally flat surface. Each tab is connected to the positive electrode current collector plate 410. Each tab may be welded to the positive electrode current collector plate 410.

The negative electrode 120 includes a negative electrode current collector foil 122 and a negative electrode active material layer 124. The negative electrode current collector foil 122 may include, for example, Cu, Ni or the like. The negative electrode current collector foil 122 includes a first region 122a and a second region 122b. The negative electrode active material layer 124 is disposed in the first region 122a. The negative electrode active material layer 124 may include, for example, graphite, Si, SiO, and the like. The second region 122b adjoins the first region 122a. The second region 122b is arranged at the axial end. The second region 122b includes a plurality of tabs. The plurality of tabs is separated in the winding direction of the wound electrode body 100. Each tab collapses radially inward. The outer surface of each tab forms a generally flat surface. Each tab is connected to the negative electrode current collector plate 420. Each tab may be welded to the negative electrode current collector plate 420.

The separator 130 is electrically insulating. The separator 130 electrically separates the positive electrode 110 from the negative electrode 120. In the radial direction, the separator 130 is disposed between the positive electrode 110 and the negative electrode 120. The separator 130 is porous. The electrolytic solution may permeate the separator 130. The separator 130 may include, for example, a porous film made of resin.

### 3. Fixing Member

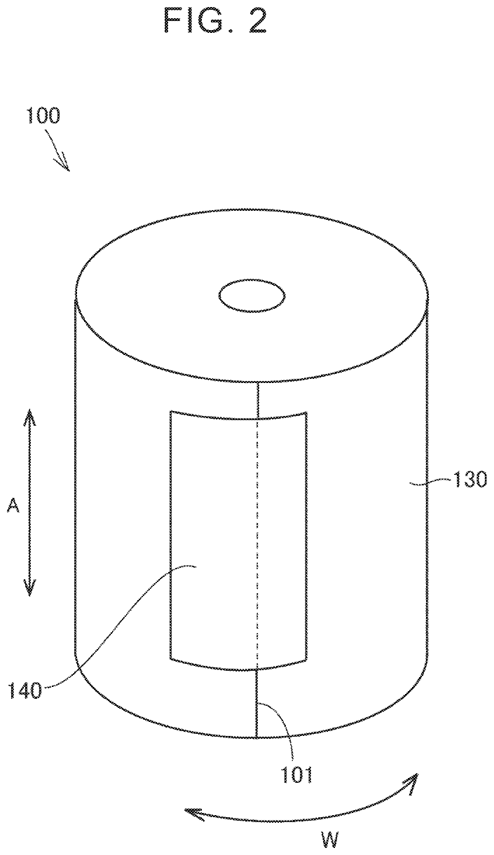

FIG. 2 is a schematic diagram illustrating an example of a wound electrode body according to the present embodiment. In FIG. 2, the winding end 101 of the wound electrode body 100 is shown. The “winding direction” is the W direction in FIG. 2 or the like. The fixing member 140 fixes the winding end 101. The fixing member 140 may straddle the winding end 101. The fixing member 140 may fix a part of the winding end 101. The fixing member 140 may fix the entire winding end 101. One fixing member 140 may be disposed. A plurality of fixing members 140 may be disposed. In the winding orientation, the fixing member 140 may be, for example, 1 to 10 mm or 3 to 7 mm wide.

### 3-1. Adhesive Component

The fixing member 140 includes an adhesive component. The adhesive component is soluble in the electrolytic solution. The adhesive component may include any component so long as it can be dissolved in the electrolytic solution. The adhesive component may be, for example, non-self-supporting. The non-self-supporting adhesive component may be supported on a base. The adhesive component may be applied to the surface of the base. The adhesive component may be impregnated into the base. The pressure-sensitive adhesive component may include, for example, at least one selected from the group consisting of an acrylic pressure-sensitive adhesive, a silicone-based pressure-sensitive adhesive, a urethane-based adhesive, and a rubber-based adhesive.

The adhesive component may be self-supporting. The self-supporting adhesive component can be used without a base. The adhesive component may include, for example, at least one selected from the group consisting of a vinyl acetate resin emulsion type adhesive, an acrylic resin emulsion type adhesive, a vinyl acetate resin solvent type adhesive, an acrylic resin solvent type adhesive, a vinyl chloride resin solvent type adhesive, a chloroprene rubber based solvent type adhesive, a chloroprene rubber based solvent type mastic type adhesive, a nitrile rubber based solvent type adhesive, a urethane resin type adhesive, an epoxy resin based adhesive, a modified silicone resin based adhesive, an epoxy modified silicone resin based adhesive, a starch based adhesive, a polymer cement mortar, an epoxy resin mortar, and a silanized urethane resin based adhesive.

All of the adhesive components may be dissolved. A portion of the adhesive component may be dissolved. By dissolving at least a portion of the adhesive component, the fixing force may be reduced. The fixing of the winding end 101 may be completely released by the dissolution of the adhesive component. The securing of the winding end 101 may be partially released.

### 3-2. Base

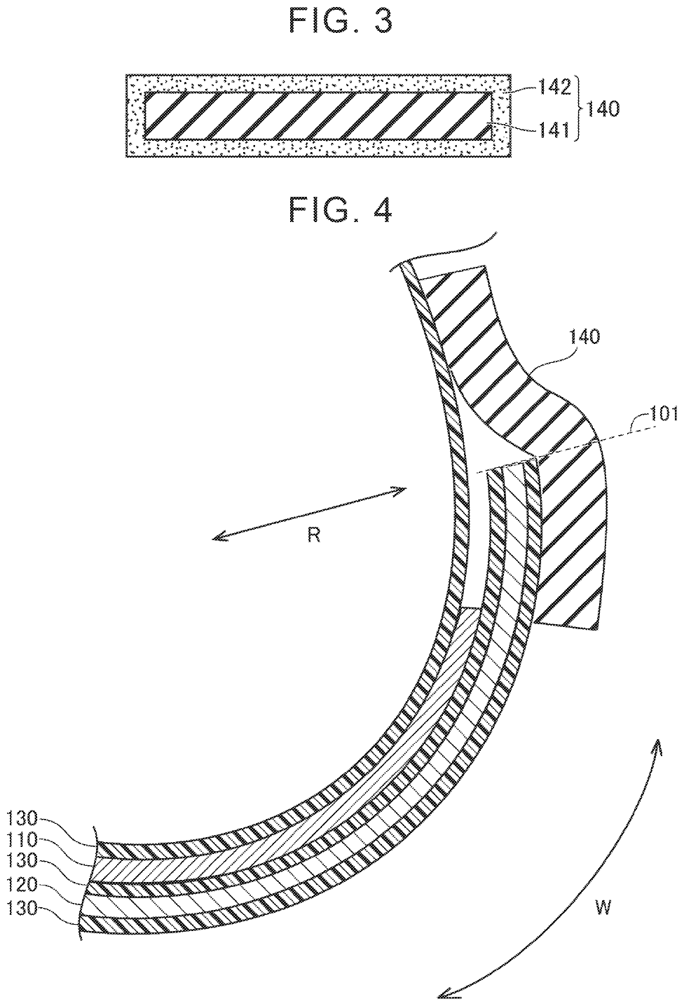

FIG. 3 is a schematic cross-sectional view illustrating an example of a fixing member according to the present embodiment. The fixing member 140 may include a base 141. The fixing member 140 may include, for example, a base 141 and an adhesive layer 142. The base 141 supports the adhesive layer 142. Since the fixing member 140 includes the base 141, the strength is expected to be improved. The base 141 may be, for example, a sheet. The base 141 may be porous, for example. The base 141 being porous may also reduce stress concentration. The base 141 may include, for example, a sponge, a nonwoven fabric, or the like.

The thickness of the base 141 may be, for example, any of 5 to 50 μm, or 10 to 30 μm. The base 141 may include, for example, at least one selected from the group consisting of polypropylene (PP), polyimide (PI), polyethylene (PE), polyethylene terephthalate (PET), and polyphenylene sulfide (PPS).

The adhesive layer 142 may be disposed on only one side of the base 141. The adhesive layer 142 may be disposed on both surfaces of the base 141. The adhesive layer 142 may cover the entire base 141. The thickness of the adhesive layer 142 may be, for example, any of 5 to 50 μm, or 10 to 30 μm. The adhesive layer 142 includes the aforementioned adhesive component. As long as the adhesive component is included, the adhesive layer 142 may include an additional component. The additional component may comprise, for example, a plasticizer or the like.

### 3-3. Example of Arrangement

FIG. 4 is a schematic cross-sectional view showing a first arrangement example. FIG. 4 to FIG. 6 show cross sections orthogonal to the axial direction of the wound electrode body 100. The “outermost layer” indicates a member of the positive electrode 110, the negative electrode 120, and the separator 130 that is located on the outermost side in the radial direction at the winding end 101. The outermost layer may be any of the positive electrode 110, the negative electrode 120, or the separator 130. In FIG. 4 to FIG. 6, as an example, the separator 130 is an outermost layer. For example, the fixing member 140 may be disposed on the outer peripheral side of the outermost layer in the radial direction. The fixing member 140 may straddle the winding end 101.

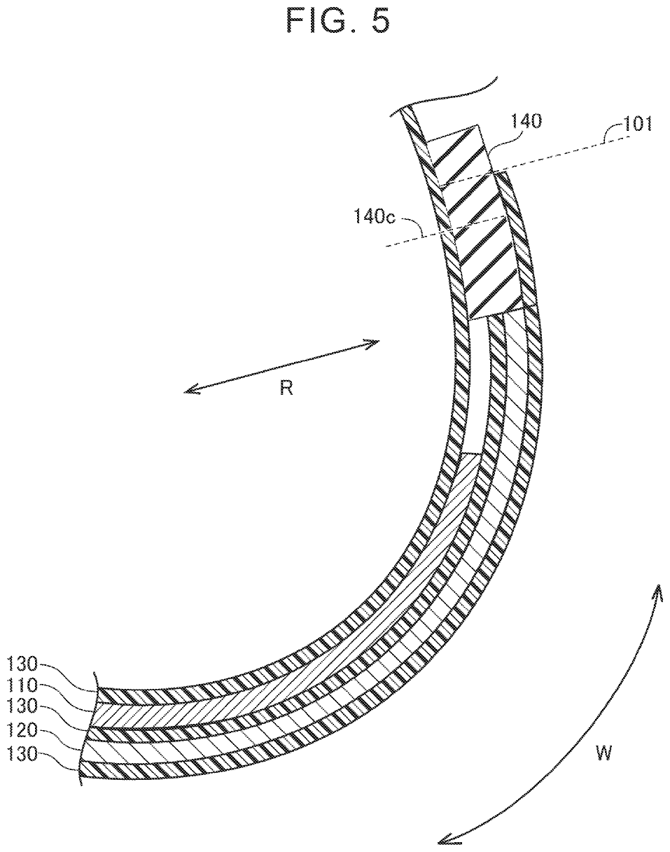

FIG. 5 is a schematic cross-sectional view illustrating a second arrangement example. For example, at least a part of the fixing member 140 may be disposed on the inner peripheral side of the outermost layer in the radial direction. The central portion 140c of the fixing member 140 may be located inside the winding end 101. Since at least a part of the fixing member 140 is disposed on the inner peripheral side of the outermost layer, it is expected to reduce the step caused by the fixing member 140. For example, the margin of the fixing member 140 from the winding end 101 may be less than or equal to half the dimension of the fixing member 140 in the winding direction.

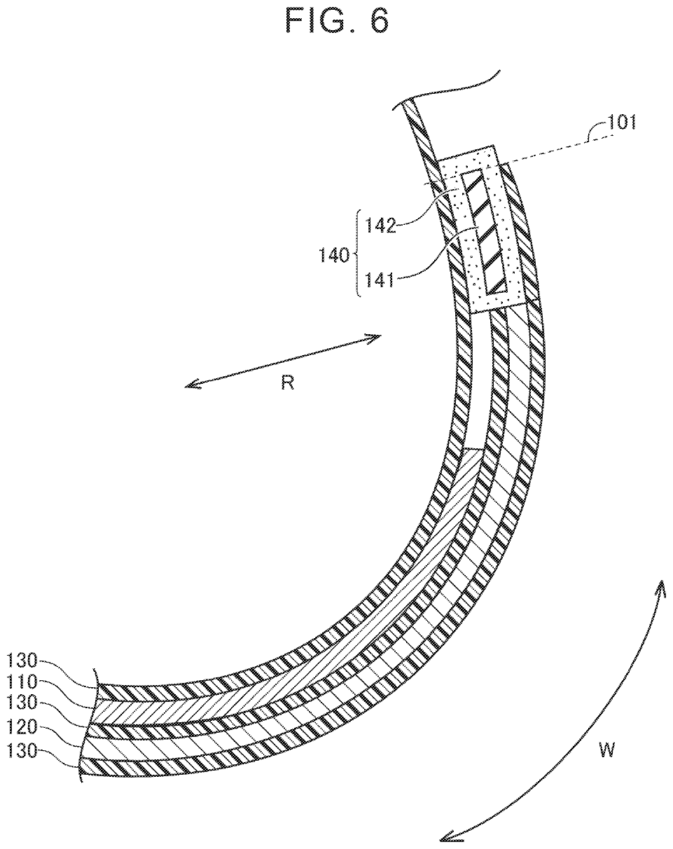

FIG. 6 is a schematic cross-sectional view illustrating a third arrangement example. At least a part of the fixing member 140 may be disposed on the inner peripheral side of the outermost layer in the radial direction. In the winding direction, the base 141 may be located inside the winding end 101. There may be no base 141 outside of the winding end 101. The third arrangement example is also expected to reduce the level difference. As long as the base 141 is located inside the winding end 101 in the winding direction, for example, the adhesive layer 142 may extend outside the winding end 101.

### 4. Electrolytic Solution

The electrolytic solution is a liquid electrolyte. The electrolytic solution includes a solute and a solvent. The electrolytic solution may further contain an optional additive. The solute comprises a supporting electrolyte. The solute may comprise, for example, at least one selected from the group consisting of LiPF₆, LiBF₄, LiN(SO₂F)₂, LiN(SO₂CF₃)₂, LiB(C₂O₄)₂, LiPO₂F₂, and FSO₃Li. The level of solute may be, for example, 0.5 to 2 mol/L.

The solvent may dissolve the adhesive component. As long as the adhesive component can be dissolved, the solvent can include any component. The solvent may include, for example, a carbonate-based solvent. The solvents may include, for example, at least one selected from the group consisting of ethylene carbonate (EC), propylene carbonate (PC), butylene carbonate (BC), dimethyl carbonate (DMC), diethyl carbonate (DEC), ethyl methyl carbonate (EMC), and fluoroethylene carbonate (FEC).

### 5. Cell Case

As shown in FIG. 1, the cell case 200 houses the wound electrode body 100, the fixing member 140, and the electrolytic solution. The cell case 200 may have any form. The cell case 200 may be cylindrical, square, or laminated. The laminated cell case 200 is made of a metal foil laminated film.

The cell case 200 may be made of metal, for example. The cell case 200 may include, for example, a peripheral wall 210, a top wall 220, and a bottom wall 230. The peripheral wall 210 may have a cylindrical outer shape. The peripheral wall 210 surrounds the outer peripheral surface of the wound electrode body 100. The peripheral wall 210 may be in contact with the outer peripheral surface of the wound electrode body 100.

The top wall 220 is connected to an axial end of the peripheral wall 210. For example, a through-hole for connecting to the external terminal 300 may be formed in a central portion of the top wall 220. In the axial direction, the bottom wall 230 faces the top wall 220. The bottom wall 230 is connected to an axial end of the peripheral wall 210. The bottom wall 230 is in contact with the negative electrode current collector plate 420.

The external terminal 300 is disposed on an outer surface of the top wall 220. In the present embodiment, the external terminal 300 has a positive polarity. The cell case 200 has a negative polarity.

The insulating member 500 electrically separates the external terminal 300 from the cell case 200. The insulating member 500 may include, for example, the first insulating portion 510 and the second insulating portion 520. The first insulating portion 510 is interposed between the external terminal 300 and the top wall 220. In the cell case 200, the second insulating portion 520 is interposed between the positive electrode current collector plate 410 and the cell case 200.

What is claimed is:

1. A power storage cell comprising a cell case, a wound electrode body, a fixing member, and an electrolytic solution, wherein:
the cell case houses the wound electrode body, the fixing member, and the electrolytic solution;
the wound electrode body is provided by winding electrodes and separators;
the fixing member fixes a winding end of the wound electrode body in a winding direction;
the fixing member includes an adhesive component; and
the adhesive component is soluble in the electrolytic solution.

2. The power storage cell according to claim 1, wherein:
the fixing member further includes a base; and
the base supports the adhesive component.

3. The power storage cell according to claim 1, wherein:
at least part of the fixing member is disposed on an inner peripheral side of an outermost layer of the wound electrode body in a radial direction of the wound electrode body; and
a central portion of the fixing member is positioned on an inner side of the winding end of the wound electrode body in the winding direction of the wound electrode body.

4. The power storage cell according to claim 2, wherein:
at least part of the fixing member is disposed on an inner peripheral side of an outermost layer of the wound electrode body in a radial direction of the wound electrode body; and
in the winding direction of the wound electrode body,
the base of the fixing member is positioned on an inner side of the winding end of the wound electrode body, and
the base of the fixing member is not positioned on an outer side of the winding end of the wound electrode body.
